(19) United States
(12) Patent Application Publication
(10) Pub. No.: US 2021/0294410 A1
(43) Pub. Date: Sep. 23, 2021

(54) Circuit Solution for Managing Power Sequencing

(71) Applicant: NVIDIA Corp., Santa Clara, CA (US)

(72) Inventors: Kedar Rajpathak, Bangalore (IN); Tezaswi Raja, San Jose, CA (US)

(73) Assignee: NVIDIA Corp., Santa Clara, CA (US)

(21) Appl. No.: 17/331,261

(22) Filed: May 26, 2021

Related U.S. Application Data
(63) Continuation-in-part of application No. 16/294,788, filed on Mar. 6, 2019.

(51) Int. Cl. G06F 1/3296; G06F 1/3206

(52) U.S. Cl. CPC G06F 1/3296; G06F 1/3206

(57) ABSTRACT

A circuit includes a supply power detector in a first power domain and a ratioed inverter in the first power domain or a second, different power domain. The supply power detector includes an output coupled to an input of the ratioed inverter, and an output of the ratioed inverter provides a power sequencing signal for the second power domain.

### CROSS-REFERENCE TO RELATED APPLICATIONS

This application claims priority and benefit as a continuation-in-part of application Ser. No. 16/294,788, “Cross domain voltage glitch detection circuit for enhancing chip security”, filed on Mar. 6, 2019, the contents of which are incorporated herein by reference in their entirety.

Modern computer chips utilize millions of transistors and other circuit elements. The circuits on a modern chip may be organized into power domains, which are different set of circuits (often in a common area on the chip) that draw power from different power sources and/or power rails (the lines or planes for distributing power on a chip). Herein, such distribution systems will be simply referred to as “rails” or “power rails” for simplicity. For various reasons known in the art, the power rails may not all energize exactly concurrently, meaning that some circuits in the system may receive power and begin operating before others. This is known as “power sequencing”.

When multiple power rails and power sequencing are utilized, the chip may be vulnerable to an operational issue known as cross-power domain signaling. This issue arises where a signal generated by a circuit in a first power domain is applied to a circuit in a second power domain. If the power rail supplying the first power domain is not yet energized, and the first power domain provides a signal to the second power domain which is powered on, the signal may have an undefined value in the second power domain. If the second power domain operates on the undefined signal the result may be unpredictable or undesirable operation of the chip.

Another issue arising with modern chips is protecting the integrated circuits on those chips against power supply glitch attacks. Glitch attacks are intrusions in chips used in devices that utilize integrated circuits for securing gaming, automotive, and server applications, for example. A glitch attack is an intentional fault introduced to undermine device security. The fault can cause instruction skipping, instruction decoding errors, and improper data read and write backs. An electrical type of glitch attack can target the clock or the power systems. A power glitch attack may involve a pull to ground (i.e., brownout) or an increase in voltage (i.e., spiking).

Supply voltage glitching is known hardware attack. By glitching the power supply voltage, a hacker may either bypass a device authentication process or enter unauthorized logic through Joint Test Action Group (JTAG) access. If glitch attacks can be detected, they may be prevented for example by resetting the circuits under attack.

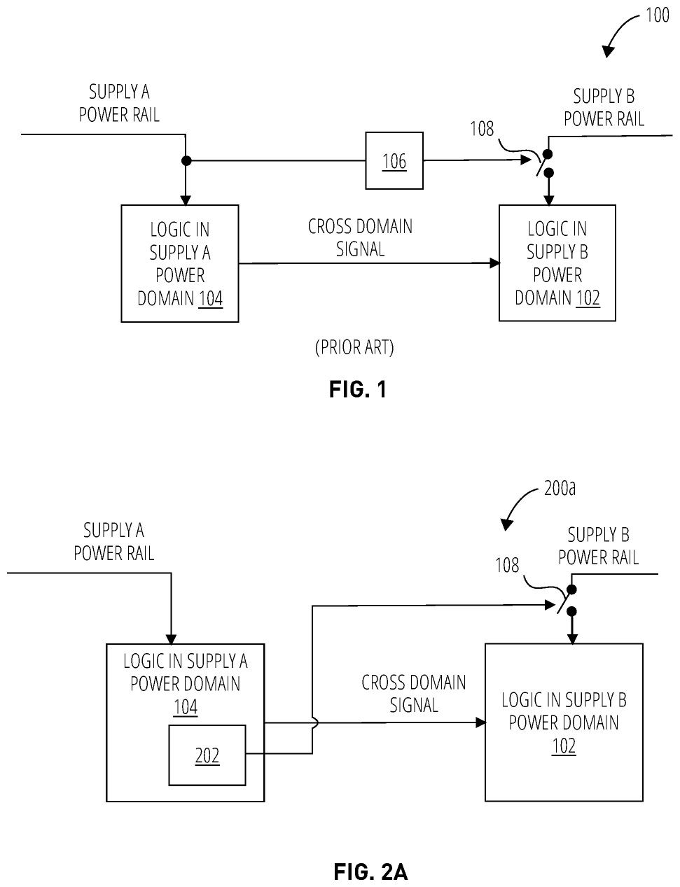

FIG. 1 depicts a conventional cross-power domain control circuit implementation 100.

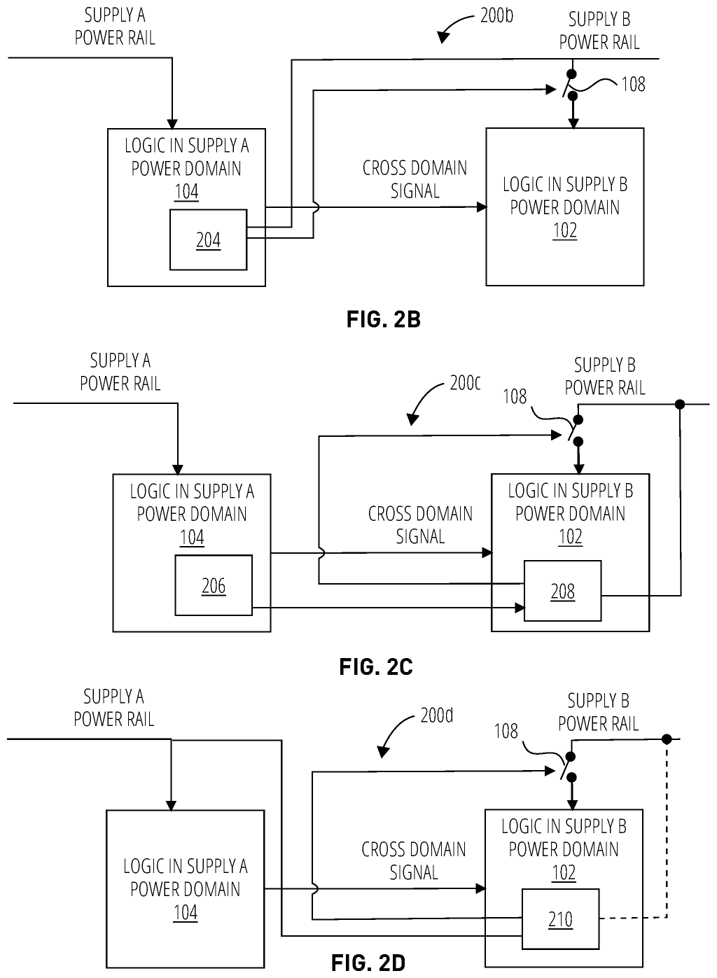

FIG. 2A depicts a cross-power domain control circuit implementation 200a in accordance with one embodiment.

FIG. 2B depicts a cross-power domain control circuit implementation 200b in accordance with another embodiment.

FIG. 2C depicts a cross-power domain control circuit implementation 200c in accordance with yet another embodiment.

FIG. 2D depicts a cross-power domain control circuit implementation 200d in accordance with yet another embodiment.

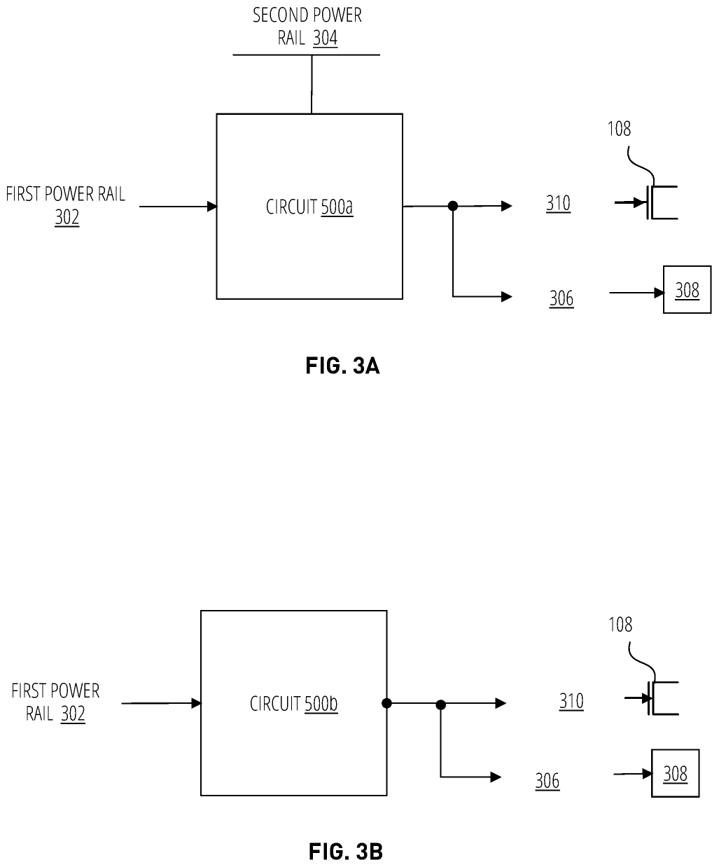

FIG. 3A depicts a circuit 500a for detecting glitch attacks and/or providing cross-domain control in accordance with one embodiment.

FIG. 3B depicts a circuit 500b for detecting glitch attacks and/or providing cross-domain control in accordance with another embodiment.

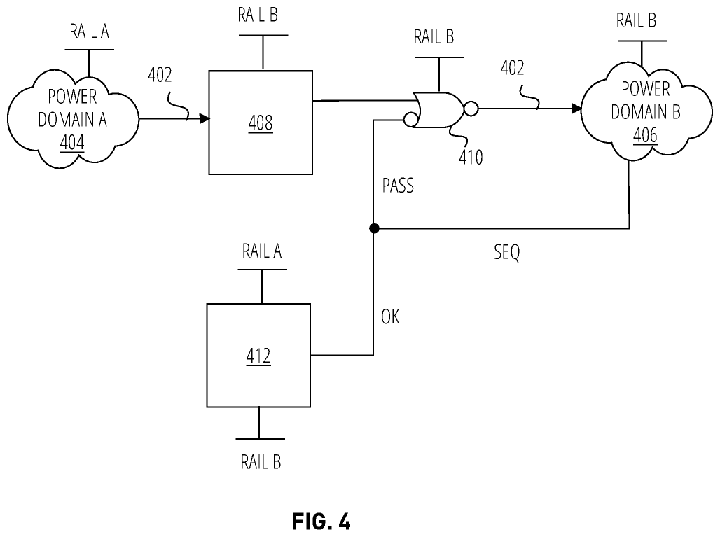

FIG. 4 depicts cross-domain control in accordance with one embodiment.

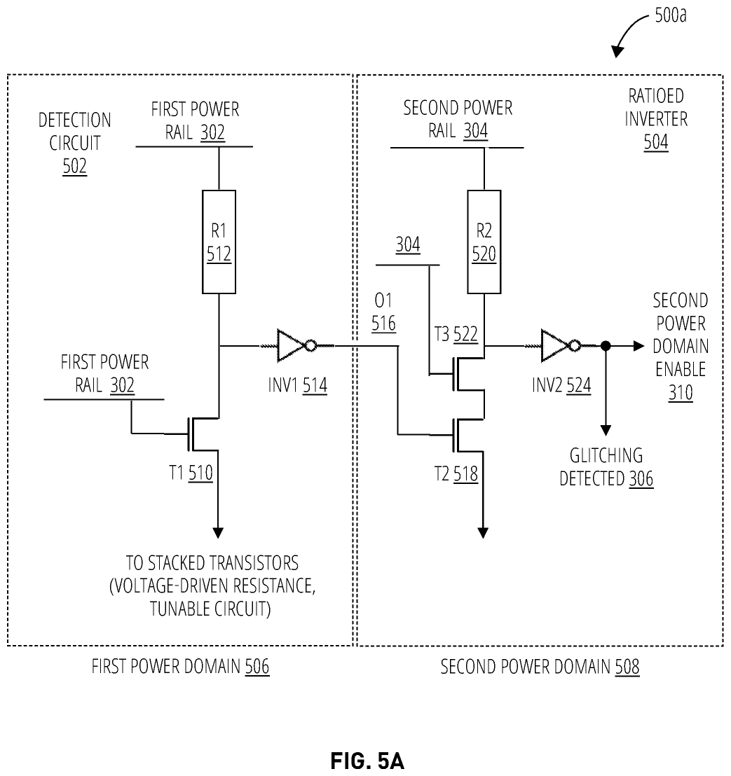

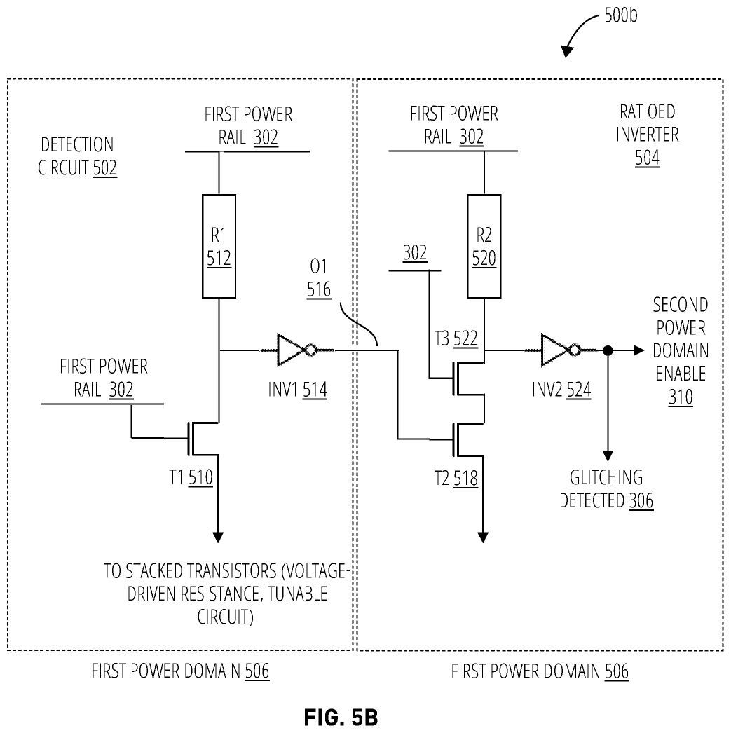

FIG. 5A depicts the circuit 500a in more detail accordance with one embodiment.

FIG. 5B depicts the circuit 500b in more detail in accordance with one embodiment.

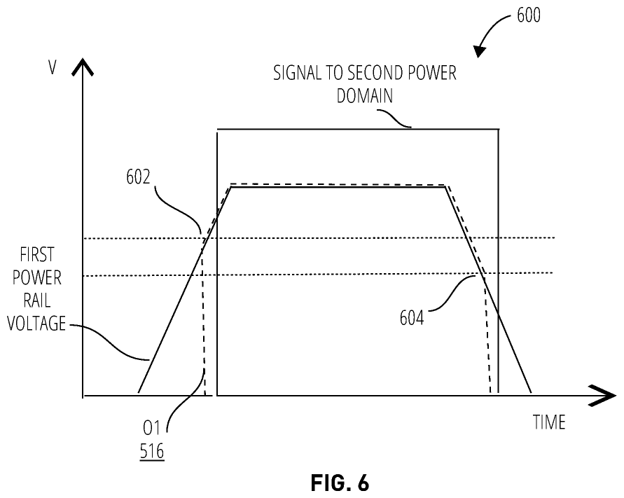

FIG. 6 depicts a voltage profile 600 in accordance with one embodiment.

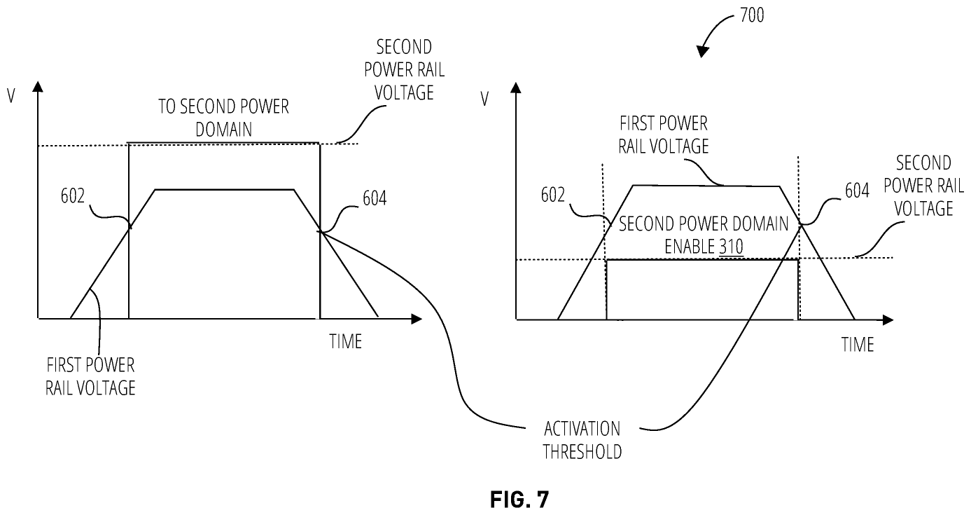

FIG. 7 depicts a voltage profile 700 in accordance with one embodiment.

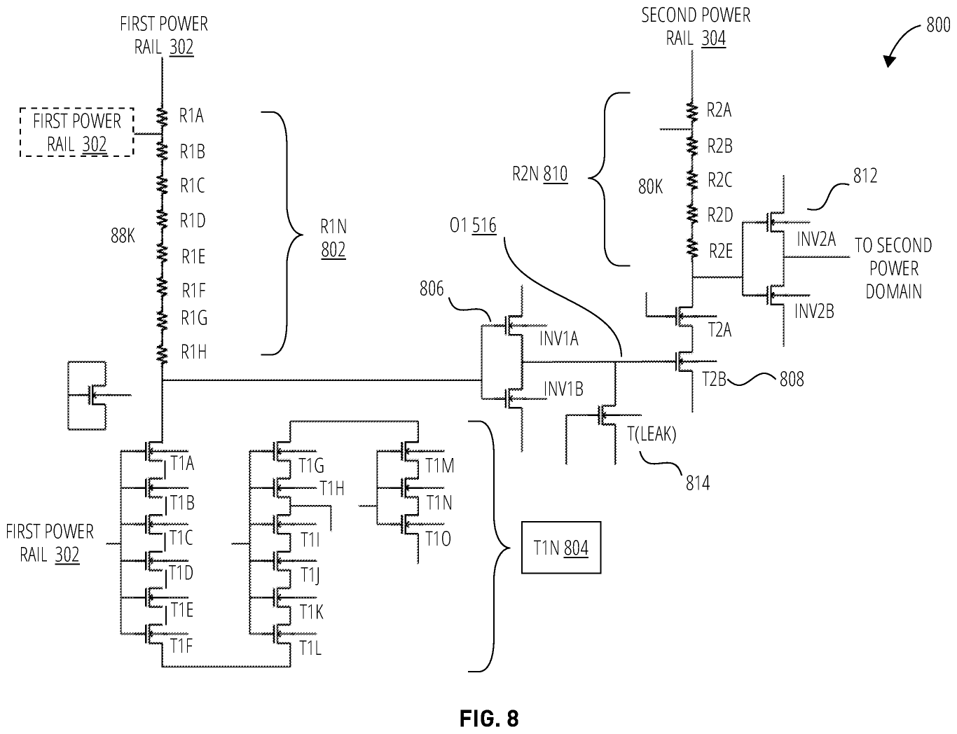

FIG. 8 depicts a cross-power domain circuit 800 in accordance with one embodiment.

Modern devices often operate circuits in multiple power domains, sometimes at different voltage levels. Power domains may include a real-time clock (RTC) domain, a system-on-a-chip (SoC) domain, a central processing unit (CPU) domain, and a graphics processing unit (GPU) domain, to name just a few examples. When signals cross power domains in such systems it is desirable to sequence power-on of the domains such that undefined signals are not operated on. Also, if a voltage glitch attack occurs on a particular power rail, then it is desirable to detect the glitch attack and respond to negate it, such as by resetting the circuit under attack.

FIG. 1 depicts a conventional cross-power domain control circuit implementation 100. The operation of logic in supply B power domain 102 depends upon a cross-domain signal from logic in supply A power domain 104. Chip-external logic 106 (outside the pin package of the chip or chips comprising logic in supply A power domain 104 and logic in supply B power domain 102) is utilized to provide power sequencing for the logic in supply A power domain 104 and logic in supply B power domain 102, such that logic in supply B power domain 102 is not powered up and made operational until logic in supply A power domain 104 is powered up and operational and the value of the cross domain signal is well-defined. A power gate 108 between the power rail and the logic in supply B power domain 102 is closed after a sufficient interval of time subsequent to activation of the power rail supplying the logic in supply A power domain 104. More generally, the power gate 108 should be understood to mean any control on providing the power to a domain. Gates used as switches are common manners of implementing a power gate 108, however other mechanisms may be utilized as well, such as intervening microcontrollers (power management chips) and mechanical switches. The chip-external logic 106 typically comprises one or more delay elements, such as R-C circuits, to provide the needed delay.

The use of chip-external logic 106 may be problematic for circuit routing, may increase area requirements, and generally may complicate system design.

FIG. 2A-FIG. 2D depict various embodiments of a cross-power domain control circuit implementation. These same implementations may also operate to provide detection and protection against supply power glitch attacks.

In the cross-power domain control circuit implementation 200a, the cross-domain control logic 202, that may also provide glitch attack detection, is disposed singly in the logic in supply A power domain 104 that supplies the cross-domain signal, and utilizes only power provided from the power rail supplying the logic in supply A power domain 104.

In the cross-power domain control circuit implementation 200b, the cross-domain control logic 204, that may also provide glitch attack detection, is disposed singly in the logic in supply A power domain 104 that supplies the cross-domain signal, and utilizes power from the power rail supplying the logic in supply A power domain 104 and also power from the power rail supplying logic in supply B power domain 102.

In the cross-power domain control circuit implementation 200c, the cross-domain power control logic, that may also provide glitch attack detection, is distributed into a first stage circuit 206 and a second stage circuit 208 in the logic in supply A power domain 104 and the logic in supply B power domain 102, respectively.

In the cross-power domain control circuit implementation 200d, the cross-domain control logic 210, that may also provide glitch attack detection, is disposed singly in the logic in supply B power domain 102, and either 1) utilizes power from the power rail supplying the logic in supply A power domain 104 and also power from the power rail supplying logic in supply B power domain 102, or b) utilizes only power provided from the power rail supplying the logic in supply A power domain 104. Thus the cross-domain control logic 210 may be implemented as either the cross-domain control logic 202 or the cross-domain control logic 204.

Referring to FIG. 3A, a circuit 500a for cross-domain control and/or glitch attack detection receives power from a first power rail 302 and a second power rail 304 and transforms these signals into an output signal that is applied to a power gate 108, and/or as a glitching detected 306 signal to a reset switch 308 for the second power domain. The supply power voltage for a circuit may be depicted herein by “VDD”.

The different power domains may operate with different voltages and voltage ranges. For example, first power rail 302 may be a fixed voltage rail maintained at (within some precision determined by the implementation requirements) 0.75 v. By contrast, second power rail 304 may vary between 1.0 v and 0.4 v (within some precision determined by the implementation requirements). These are only examples.

When the output of the circuit 500a is applied to detect glitch attacks, second power domain receiving the output signal may take certain actions. For example, output signal may be applied to initiate any one or more of a chip reset, disabling secure logic blocks, alerting a master CPU, alerting a controller, and disconnecting power rails.

The circuit 500b is utilized similarly to the circuit 500a except that it only utilizes the first power rail 302 as an input and does not utilize the second power rail 304.

FIG. 4 depicts application of cross-domain control logic in one embodiment. A cross-domain signal 402 from power domain A 404 to power domain B 406 is intermediated by voltage level shifter 408 and a NOR gate 410. The voltage level shifter 408 adjusts a voltage level of the cross-domain signal 402 to the power rail level of power domain B 406. The NOR gate 410 receives an enable and/or glitch attack detection signal from the cross-power domain control circuit 412, which in the depicted embodiment may be distinct from both of power domain A 404 and power domain B 406. Alternatively, as depicted in FIG. 2A-FIG. 2D, the cross-power domain control circuit 412 may also be implemented as part of either power domain A 404 and power domain B 406, or distributed between them. On condition that the OK signals from the cross-power domain control circuit 412 is asserted, the cross-domain signal 402 is prevented from propagating to power domain B 406 (PASS) and/or the power sequencing of power domain B 406 (SEQ) is controlled.

Referring to FIG. 5A, the circuit 500a in one embodiment comprises a detection circuit 502 and a ratioed inverter 504 for use between a first power domain 506 and a second power domain 508. The detection circuit 502 is coupled to the first power rail 302 in the power domain to be sensed for a glitch attack, or that originates a cross-domain signal. The ratioed inverter 504 is coupled to the second power rail 304 of the second power domain. “Ratioed inverter” refers to a bi-stable device, such as a binary inverter, with an input coupled to an inner node of a voltage or current divider.

In the detection circuit 502, the circuit element T1 510 may be a single transistor or may be a plurality of transistors in series or other switching circuit. A series of stacked transistors may be utilized to provide a voltage-driven resistance, thus providing a field-tunable circuit (a circuit that's operation may be adjusted after deployment in a device).

In the detection circuit 502, the first power rail 302 is coupled to a first pull-up resistor R1 512. A first inverter INV1 514 may be coupled to a junction node of the first pull-up resistor R1 512 and the first pull-down transistor T1 510. The first pull-down transistor T1 510 may also be coupled to other devices in the first power domain 506, such as a stack of additional transistors.

The output of detection circuit 502, O1 516, drives a pull-down transistor T2 518 of the ratioed inverter 504 energized by the second power rail 304 supplying the second power domain. The function of pull-down transistors is well-understood in the art.

The ratioed inverter 504 operates as a voltage level translator and may comprise a second pull-up resistor R2 520 and a pull-down transistor T2 518 in series, which may be NMOS or PMOS. A “pull-up resistor” refers to a resistor used to enable and maintain a known state for a signal. For a switch that connects to ground, a pull-up resistor maintains a well-defined voltage (i.e. VDD) across the remainder of the circuit when the switch (here, T2 518) is open. An additional transistor or transistors T3 522 may be utilized to provide electrical isolation of the output of the ratioed inverter 504 from the detection circuit 502. The outputs 310, 306 of the circuit in this example are provided via an inverter INV2 524.

The circuit 500b embodiment depicted in FIG. 5B is similar to that circuit 500a, except that both the detection circuit 502 and the ratioed inverter 504 operate on power from the first power rail 302.

FIG. 6 and FIG. 7 depict exemplary voltage profiless 600, 700 for the circuit embodiments disclosed herein. A supply voltage from a first power rail 302 in a first power domain is transformed into the signal O1 516 and passed to a ratioed inverter to drive a pull-down transistor in the second power domain. When the voltage first supply voltage is at an operationally normal value the signal O1 516 is logical “1”. The second pull-down transistor in the ratioed inverter is turned ON, and the signal to the second power domain is “1”. This may be applied to enable a power gate to power up the circuits in the second power domain.

When first power supply voltage is below a threshold value, then output O1 516=“0”. The pull-down transistor in the ratioed inverter is OFF, and the signal to the second power domain is “0”. This may be applied to trigger actions to respond to the irregular voltage in the first power supply, or to disable power to the second power domain.

As voltage profile 600 depicts, the power supply voltage level to the second power domain remains within a normal operating range during any glitch.

In various embodiments, there is a trip voltage V_trip_up 602 for a ramping up voltage in the first power domain, and a trip voltage V_trip_down 604 for a ramping down voltage in the first power domain. If the first power domain voltage is >V_trip_up 602, then the signal to the second power domain =“1”, indicating that no glitches have been detected, and/or that it is safe to power on the second power domain. If the first power domain voltage is <V_trip_down 604, then the signal to the second power domain =“0”, indicating that glitches have been detected, and/or that it is not safe to power on the second power domain.

When one or both trip points (V_trip_down 604 and V_trip_up 602) are outside the normal operating voltages of the second power domain power rail, the circuit may be deployed solely within the first power domain for power sequencing and/or glitch attacks on the second power domain.

Supply power voltage variations may affect the response time when the circuit asserts or de-asserts an output through the pull-up resistor R2 520 in the ratioed inverter. The response time may be adjusted by replacing R2 520 with a different value resistor or by adding additional resistors in series with R2 520.

Referring to the cross-power domain circuit 800, a power rail voltage of the RTC domain, first power domain 104, is coupled to a first pull-up resistor R1n 802 that is in series with a drain of first pull-down transistor T1n 804. R1n 802 may be a single resistor or a plurality of resistors in series (e.g., R1A-R1H). As an example, if a different resistance is desired, first power rail 302 may be coupled to the junction node between R1A and R1B instead of directly to R1A. In the depicted example, pull-up resistor R1n 802 has a value of 88k ohms. T1n 804 may be a single transistor or may be a plurality of transistors in series (i.e., stacked transistors T1A-T1O). These stacked transistors provide voltage driven resistance, thus providing a field tunable circuit. Additionally, first power domain 104, is coupled to the gate of first pull-down transistor T1n 804.

A first inverter INV1A/B 806 may be coupled to a junction node of the first pull-up resistor R1n 802 and the drain of first pull-down transistor T1n 804. The source of the first pull-down transistor T1n 804 may be coupled to other devices in the first power domain. The output signal from INV1A/B 806 is O1 516, which is passed to the ratioed inverter in the second power domain domain.

Referring to the ratioed inverter, the signal O1 516 is coupled to the gate of a second pull-down transistor T2A/B 808. A voltage second power rail 304 may be coupled to a second pull-up resistor R2n 810 in series with the second pull-down transistor T2A/B 808, which may be NMOS or PMOS. R2n 810 may be a single resistor or a plurality of resistors in series (e.g., R2A-R2E). As an example, if a different resistance is desired, second power rail 304 may be coupled to the junction node between R2A and R2B instead of directly to R2A. In the depicted example, pull-up resistor R2n 810 has a value of 80K ohms. T2A/B 808 may be a single transistor or may be a plurality of transistors in series (i.e., stacked transistors T2A-T2B).

A second inverter INV2A/B 812 may be coupled to a junction node of the second pull-up resistor R2n 810 and the drain of the second pull-down transistor T2A/B 808. The source of the second pull-down transistor T2A/B 808 may be coupled to other devices in the second power domain. The output signal from the second inverter INV2A/B 812 is second power domain enable 310/glitch alert, which is applied to trigger actions in the second power domain.

The cross-power domain circuit 800 may also include a leaker/off device T(leak) 814 to discharge residual charges. An additional function of the second pull-down transistor T2A may be to cut the parasitic RC charging path from the SoC to O1 516. In an embodiment, T1M-T1O of the first pull-down transistor T1n 804 are provided for post silicon tuning if required.

### LISTING OF DRAWING ELEMENTS

100 conventional cross-power domain control circuit implementation

102 logic in supply B power domain

104 logic in supply A power domain

106 chip-external logic

108 power gate

200a cross-power domain control circuit implementation

200b cross-power domain control circuit implementation

200c cross-power domain control circuit implementation

200d cross-power domain control circuit implementation

202 cross-domain control logic

204 cross-domain control logic

206 first stage circuit

208 second stage circuit

210 cross-domain control logic

302 first power rail

304 second power rail

306 glitching detected

308 reset switch

310 second power domain enable

402 cross-domain signal

404 power domain A

406 power domain B

408 voltage level shifter

410 NOR gate

412 cross-power domain control circuit

500a circuit

500b circuit

502 detection circuit

504 ratioed inverter

506 first power domain

508 second power domain

510 T1

512 R1

514 INV1

516 O1

518 T2

520 R2

522 T3

524 INV2

600 voltage profile

602 V_trip_up

604 V_trip_down

700 voltage profile

800 cross-power domain circuit

802 R1n

804 T1n

806 INV1A/B

808 T2A/B

810 R2n

812 INV2A/B

814 T(leak)

The specific voltages, amperages, and other details described above are for illustrative purposes only. The invention may be practiced using a variety of specific voltage levels, currents, resistances, and so forth. And while the invention has been described above in the context of e.g. a processor transmitting data to a memory, the PAM-4 etc. signaling techniques described herein may be practiced in any of a wide variety of signaling systems in which data is sent from a transmitting device to a receiving device, or between transceiving devices, and so forth.

Terms used herein should be accorded their ordinary meaning in the relevant arts, or the meaning indicated by their use in context, but if an express definition is provided, that meaning controls.

“Logic” herein refers to machine memory circuits, non-transitory machine-readable media, and/or circuitry that by way of its material and/or material-energy configuration comprises control and/or procedural signals, and/or settings and values (such as resistance, impedance, capacitance, inductance, current/voltage ratings, etc.), that may be applied to influence the operation of a device. Electronic circuits such as controllers, field programmable gate arrays, processors, and memory (both volatile and nonvolatile) comprising processor-executable instructions are examples of logic. Logic specifically excludes pure signals or software per se (however does not exclude machine memories comprising software and thereby forming configurations of matter).

Various logic functional operations described herein may be implemented in logic that is referred to using a noun or noun phrase reflecting said operation or function. For example, an association operation may be carried out by an “associator” or “correlator”. Likewise, switching may be carried out by a “switch”, selection by a “selector”, and so on.

Those skilled in the art will appreciate that logic may be distributed throughout one or more devices or components, and/or may be comprised of combinations memory, media, processing circuits and controllers, other circuits, and so on. Therefore, in the interest of clarity and correctness logic may not always be distinctly illustrated in drawings of devices and systems, although it is inherently present therein. The techniques and procedures described herein may be implemented via logic distributed in one or more computing devices. The particular distribution and choice of logic will vary according to implementation.

Within this disclosure, different entities (which may variously be referred to as “units,” “circuits,” other components, etc.) may be described or claimed as “configured” to perform one or more tasks or operations. This formulation—[entity] configured to [perform one or more tasks]—is used herein to refer to structure (i.e., something physical, such as an electronic circuit). More specifically, this formulation is used to indicate that this structure is arranged to perform the one or more tasks during operation. A structure can be said to be “configured to” perform some task even if the structure is not currently being operated. A “credit distribution circuit configured to distribute credits to a plurality of processor cores” is intended to cover, for example, an integrated circuit that has circuitry that performs this function during operation, even if the integrated circuit in question is not currently being used (e.g., a power supply is not connected to it). Thus, an entity described or recited as “configured to” perform some task refers to something physical, such as a device, circuit, memory storing program instructions executable to implement the task, etc. This phrase is not used herein to refer to something intangible.

The term “configured to” is not intended to mean “configurable to.” An unprogrammed FPGA, for example, would not be considered to be “configured to” perform some specific function, although it may be “configurable to” perform that function after programming.

Reciting in the appended claims that a structure is “configured to” perform one or more tasks is expressly intended not to invoke 35 U.S.C. § 112(f) for that claim element. Accordingly, claims in this application that do not otherwise include the “means for” [performing a function] construct should not be interpreted under 35 U.S.C § 112(f).

As used herein, the term “based on” is used to describe one or more factors that affect a determination. This term does not foreclose the possibility that additional factors may affect the determination. That is, a determination may be solely based on specified factors or based on the specified factors as well as other, unspecified factors. Consider the phrase “determine A based on B.” This phrase specifies that B is a factor that is used to determine A or that affects the determination of A. This phrase does not foreclose that the determination of A may also be based on some other factor, such as C. This phrase is also intended to cover an embodiment in which A is determined based solely on B. As used herein, the phrase “based on” is synonymous with the phrase “based at least in part on.”

As used herein, the phrase “in response to” describes one or more factors that trigger an effect. This phrase does not foreclose the possibility that additional factors may affect or otherwise trigger the effect. That is, an effect may be solely in response to those factors, or may be in response to the specified factors as well as other, unspecified factors. Consider the phrase “perform A in response to B.” This phrase specifies that B is a factor that triggers the performance of A. This phrase does not foreclose that performing A may also be in response to some other factor, such as C. This phrase is also intended to cover an embodiment in which A is performed solely in response to B.

As used herein, the terms “first,” “second,” etc. are used as labels for nouns that they precede, and do not imply any type of ordering (e.g., spatial, temporal, logical, etc.), unless stated otherwise. For example, in a register file having eight registers, the terms “first register” and “second register” can be used to refer to any two of the eight registers, and not, for example, just logical registers 0 and 1.

When used in the claims, the term “or” is used as an inclusive or and not as an exclusive or. For example, the phrase “at least one of x, y, or z” means any one of x, y, and z, as well as any combination thereof.

1. A circuit comprising:
a supply power detection circuit comprising a first pull-up resistor and a first pull-down transistor series coupled at a first junction node;
a ratioed inverter coupled to be driven from the first junction node, the ratioed inverter comprising a second pull-up resistor and a second pull-down transistor series coupled at a second junction node; and
the second junction node coupled to provide a cross-domain power sequencing signal.

2. The circuit of claim 1, the detection circuit and the ratioed inverter each disposed in a different power domain.

3. The circuit of claim 1, the detection circuit and the ratioed inverter both disposed in a same power domain.

4. The circuit of claim 1, the detection circuit comprising a first inverter coupled between the first junction node and the ratioed inverter.

5. The circuit of claim 4, the ratioed inverter comprising a second inverter coupled to provide the cross-domain power sequencing signal from the second junction node.

6. A circuit comprising:
a supply power detector in a first power domain;
a ratioed inverter in a second power domain different than the first power domain;
the supply power detector comprising an output coupled to an input of the ratioed inverter; and
an output of the ratioed inverter coupled to provide a power sequencing signal for the second power domain.

7. The circuit of claim 6, wherein the output of the ratioed inverter is coupled to a power gate on a power rail of the second power domain.

8. The circuit of claim 6, the detector comprising a first pull-up resistor and a first pull-down transistor series coupled to a first junction node comprising the output of the supply power detector.

9. The circuit of claim 8, the ratioed inverter comprising a second pull-up resistor and a second pull-down transistor series coupled to a second junction node providing the power sequencing signal.

10. The circuit of claim 9, the first junction node and the second pull-down transistor coupled through a first inverter.

11. The circuit of claim 8, the first pull-down transistor driven by a power rail of the first power domain.

12. The circuit of claim 6, the detector comprising a tuning circuit providing a variable resistance.

13. The circuit of claim 1, wherein the output of the ratioed inverter is further coupled to provide a glitch attack detection signal.

14. The circuit of claim 13, wherein the glitch attack detection signal is applied to one or more of a reset circuit, a circuit to disable secure logic blocks, a processor, a controller, and a power control.

15. A method of power sequencing circuits in a plurality of power domains, the method comprising:
receiving a supply voltage at a detector in a first power domain to generate a first output signal; and
applying the first output signal to a ratioed inverter to generate a power sequencing signal for a second power domain.

16. The method of claim 15, the detection circuit comprising a first pull-up resistor and a first pull-down transistor series coupled at a first junction node.

17. The method of claim 16, the ratioed inverter comprising a second pull-up resistor and a second pull-down transistor series coupled at a second junction node.

18. The method of claim 17, the first junction node driving the second pull-down transistor.

19. The method of claim 18, the first pull-down transistor driven by a power rail of the first power domain.

20. The method of claim 15, wherein the power sequencing signal indicates an operating condition in the first power domain such that:
on condition the supply voltage in the first power domain is operating within a range that does not cause a trip, the power sequencing signal indicates a normal operating condition to the second power domain and is asserted in the second power domain; and
on condition the supply voltage in the first power domain is operating within a range that causes the trip, the power sequencing signal indicates an abnormal operating condition to the second power domain and is de-asserted in the second power domain.
